(19) United States
(12) Patent Application Publication
(10) Pub. No.: US 2007/0220026 A1
(43) Pub. Date: Sep. 20, 2007

(54) Efficient caching for large scale distributed computations

(75) Inventors: Michael A. Isard, San Francisco, CA (US); Yuan Yu, Cupertino, CA (US)

Correspondence Address: WOODCOCK WASHBURN LLP (MICROSOFT CORPORATION), CIRA CENTRE, 12TH FLOOR, 2929 ARCH STREET, PHILADELPHIA, PA, 19104-2891, US

(73) Assignee: Microsoft Corporation, Redmond, WA (US)

(21) Appl. No.: 11/378,417

(22) Filed: Mar. 17, 2006

(51) Int. Cl. G06F 7/00

(52) U.S. Cl. 707/101

(57) ABSTRACT

Caching is provided to speed up the recomputation of an application, function, or other computation that relies on a very large input dataset, when the input dataset is changed. Previous computation results are stored in storage, for example, in a system-wide, global, persistent cache server. The storage enables the reuse of previous results on the parts of the dataset that are old and unchanged, and to only run the computation on the parts of the dataset that are new or changed. The application then combines the results of the two parts to form the final result.

### BACKGROUND

Many large-scale computations compute a function on a very large input dataset. Examples include data mining applications that process huge amounts of raw data collected from the web. Such computations are extremely time consuming, and must be recomputed after the input dataset is updated. Because the input dataset changes frequently, regular reruns of hundreds of computations that depend on the same input could be performed simultaneously. This causes severe contentions of the finite computing resources available to these computations.

### SUMMARY

Caching is provided to speed up the recomputation of an application, function, or other computation that relies on a very large input dataset, when the input dataset is changed. Previous computation results are stored in storage, for example, in a system-wide, global, persistent cache server. The storage enables the reuse of previous results on the parts of the dataset that are old and unchanged, and to only run the computation on the parts of the dataset that are new or changed. The application then combines the results of the two parts to form the final result.

This Summary is provided to introduce a selection of concepts in a simplified form that are further described below in the Detailed Description. This Summary is not intended to identify key features or essential features of the claimed subject matter, nor is it intended to be used to limit the scope of the claimed subject matter.

### BRIEF DESCRIPTION OF THE DRAWINGS

FIG. 1 is a flow diagram of an example computation method.

FIG. 2 is a block diagram of an example system.

FIG. 3 is a diagram of an example dataset.

FIG. 4 is a flow diagram of another example computation method.

FIG. 5 is a diagram of another example dataset.

FIG. 6 is a diagram of another example dataset.

FIG. 7 is a flow diagram of another example computation method.

FIG. 8 is a block diagram of an example computing environment in which example embodiments and aspects may be implemented.

### DETAILED DESCRIPTION

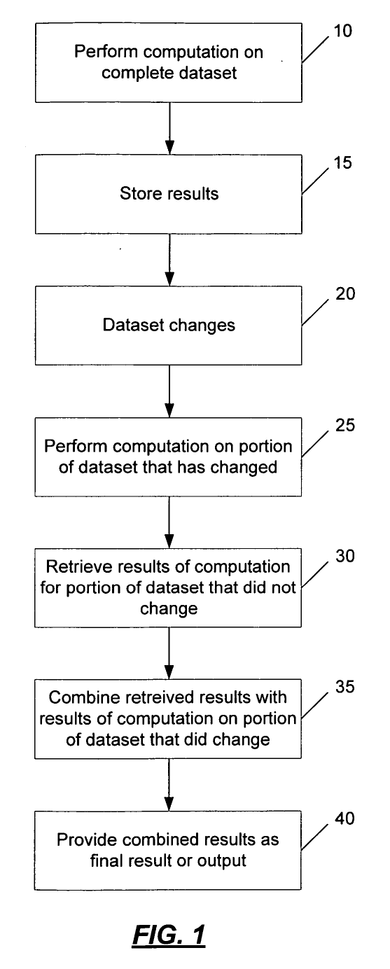

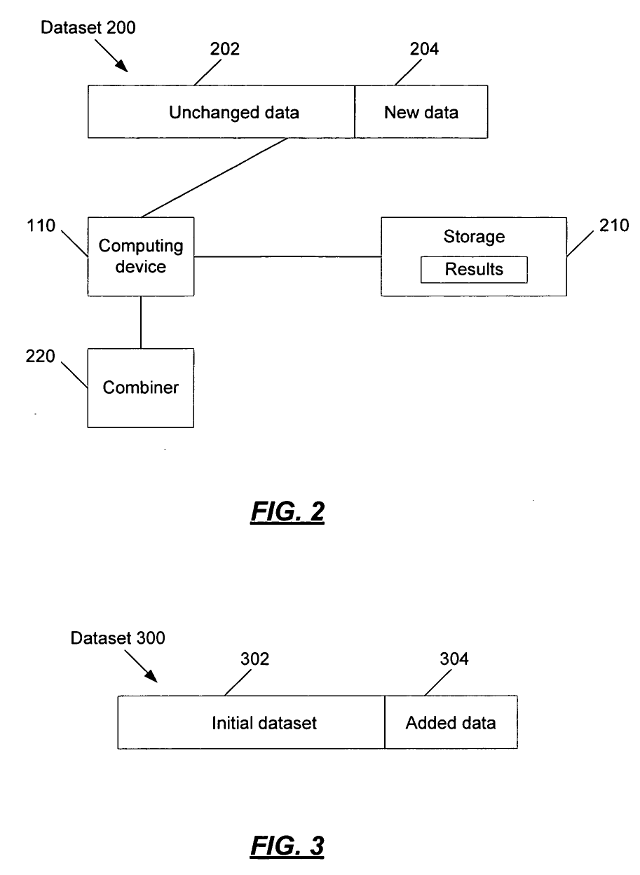

FIG. 1 is a flow diagram of an example computation method, and FIG. 2 is a block diagram of an example system. A computation that relies on a large dataset 200 (e.g., 1-10 terabytes) is performed at step 10 using a computing device 110, for example, and saved in storage 210 at step 15. The storage 210 may be a system-wide cache server that caches intermediate results at some granularity. At some point, the dataset 200 may change at step 20. At this point, the dataset 200 may comprise a portion 202 of unchanged data and a portion 204 of new data.

When the computation is to be performed again at some later time on the dataset 200, at step 25, desirably the computation is performed only on the portion 204 of the dataset that has changed. In this manner, because the computation is being performed on only a subset of the dataset 200, the computation may be executed more quickly and efficiently.

At step 30, the results of the computation for the portion 202 of the dataset that had been saved in storage 210 (from step 15) are retrieved. At step 35, the results of the computation on the portion 204 having the new data are combined with the retrieved results for the portion 202 of the dataset that has not changed, to obtain the final result of the computation on the dataset. A combiner 220, local or remote to the computing device 110 for example, may be employed to perform the combination. The final result is provided at step 40.

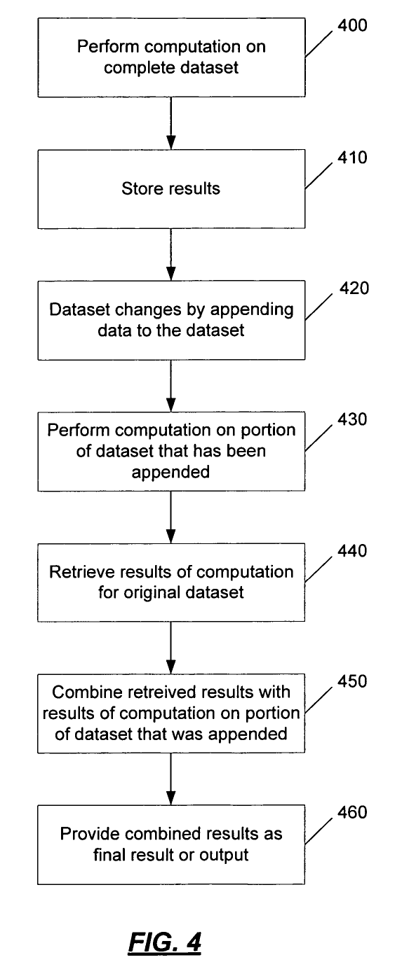

In some datasets, data cannot be written into the middle of the dataset, and can only be added or appended onto the existing dataset. Thus, the dataset may be changed in a disciplined way, such as by appending new data onto the existing data in the dataset, for example. In other words, the dataset may incrementally change. In such a dataset, it is desirable to compute the function incrementally, and not recompute the function over the entire dataset. FIG. 3 shows an example diagram of a dataset that is changed by appending. In the example, the portion 302 of the dataset 300 corresponds to the initial dataset. The data is changed by appending new data to the dataset 300. Therefore, new data is received and stored in the dataset 300 as a portion 304, e.g., at the “tail” of the dataset 300. In such a scenario, most of the data in the dataset 300 remains unchanged, and the only changed data is that data in the newly appended portion 304.

FIG. 4 is a flow diagram of an example computation method using a dataset that is changed by appending. Similar to that described with respect to FIG. 2, a computation that relies on a large dataset 300 is performed at step 400 and saved in storage at step 410. At some point, the dataset 300 may change at step 420 by appending a data portion 304 to the data portion 302. The data portion 304 may be uniquely identified.

When the computation is to be performed again at some later time on the dataset 300, at step 430, the computation is performed only on the portion 304 of the dataset that has been appended. Because the portion 304 has been appended, and may be uniquely identified, it may be quickly and efficiently located for computation.

At step 440, the results of the previous computation (e.g., for the previous dataset, made up in its entirety of data portion 302) that had been saved in storage are retrieved. At step 450, the results of the computation on the appended portion 304 having the new data are combined with the retrieved results for the portion 302 of the dataset (which was the complete dataset 300 previously), to obtain the final result of the computation on the dataset. The final result is provided at step 460.

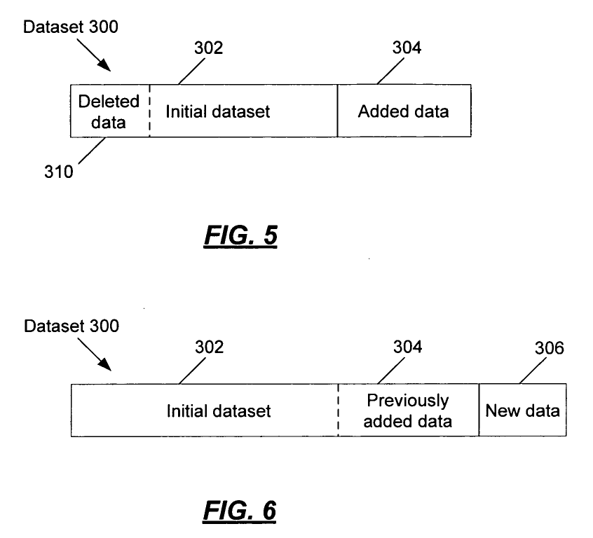

Alternately, in addition to data being appended to the dataset, data may be removed or deleted from the dataset, e.g., from the “head” of the dataset 300. In this manner, the portion 302 of the dataset will not stay unchanged, but will lose some data, e.g., the data portion 310, as shown in FIG. 5. This change to the data portion 302 will desirably be accounted for when the results for the portion 302 are retrieved (e.g., at step 450) for subsequent combination with the results for the appended data portion 304. In some datasets, data can be removed from the head of the dataset and not from the middle of the dataset. The amount of data that is removed from the dataset may be predetermined or based on the size of the added data portion, for example.

During subsequent computation iterations, as new data is appended, for example, and additional computations are scheduled and performed (e.g., daily or weekly or as desired), the data that had been previously appended (and used in computations) is desirably treated as belonging to the data portion that is unchanged (e.g., the portion 302), and only the data that has been added or appended to the dataset since the last computation is used in the current computation.

In such a scenario, for example with reference to the example block of data shown in FIG. 6, the data portions 302 and 304 are treated as unchanged data and are not used in subsequent computation (the computation for the data in the portions 302 and 304 being previously performed and stored for subsequent retrieval), and only the data in the newly appended data portion 306 is used for the current computation. The result of the computation on the data portion 306 is then combined with the previously stored results for the portions 302 and 304. It is noted that if data is changed in the portions 302 and 304, then these changes are accounted for in the current computation as well (e.g., the computation is performed on the changed values in the portions 302 and 304).

As a further example, consider a large input dataset and an application that computes a function F on the dataset. Both the input dataset and the output result of the function are stored in storage (e.g., a cache). The input dataset may be distributed among a large collection of machines. The output result is denoted as Output =F(Input). The input dataset is changed on a regular basis, which otherwise would result in repeated reruns of the same application. However, here, the previously computed result of the function F may be used if the input dataset is not changed. If the input dataset is changed by adding or appending new data to the dataset, the previously computed result of the function F may also be used.

More particularly, let the new data be X. Define a combiner function C such that F(Append(Input, X))=C(F(Input), F(X)). So if there is a cached result (Output) of F(Input), the Output may be obtained from the cache, and C(Output, F(X)) may be used to compute the final result, instead of again performing the entire computation using the entire input dataset.

This process may be recursively applied. As long as the function F and the combiner function C are unchanged, then Output_(n+1)=C(Output_n, F(Xn)), where n is the iteration number. Thus, a lot of computation is avoided, and a desired property of incrementality may be obtained in that the computation is proportional to the amount of data that has changed, and not to the size of entire input dataset.

The combiner function C may be provided or generated by the application writer, for example, desirably written in the same programming language as the function F. C generally will be less complex than F and straightforward to write, most likely as a parallel composition of F(X) with the cached result of the previous computation. The small cost of writing C is offset by the large savings that results in avoiding the recomputation of the entire dataset.

Providing C is optional. However, if an application writer does not provide or otherwise generate C, there will be a cache hit only when the input dataset has not been changed. In the event of a changing input dataset, the application will not compute as quickly or efficiently.

For a large class of functions, the combiner C is straightforward. This is in particular true for functions that can be computed using the map and reduce paradigm. Sometimes, when the output is computed, there may be some intermediate results that could be used to produce a more efficient combiner C. Some example functions and combiners are provided.

1. Distributed grep:
F=(matchˆ10>=merge)ˆ20>=merge;
C=merge;

In this example, it is desired to retrieve all the items in a dataset that match a certain pattern. Here, assume that there is a known “match” computation and a “merge” computation. There are 200 matches. Each match works on 1/200 of the input dataset. They are grouped into 20 groups of 10 matches each. Each group goes to a merge, which is then subsequently merged again to form the final output. If there is a delta (new data appended to the input dataset), the delta is provided into a match, and is then merged with the output to get the new output.

2. Distributed sort:
F=(sortˆ50>>merge)ˆ30>>merge;
C=merge;

In this example, it is desired to sort all the items in a dataset in some order. Here, assume that there is a known “sort” computation and a “merge” computation. There are 1500 sorts. Each sort works on 1/1500 of the input dataset. They are grouped into 30 groups of 50 sorts each. Each group goes to a merge, which is then subsequently merged again to form the final output. If there is a delta (new data appended to the input dataset), the delta is provided into a sort, and is then merged with the output to get the new output.

A further caching example is now described. Assume that the input and output of an application are streams stored in a data store. A stream, such as an input file, comprises an ordered list of extents. An extent may be a subset of data, such as a subset of the complete set of data. A stream may be an append-only file, meaning that new contents can only be added by either appending to the last extent or appending a new extent. A stream may be used to store input, output, and/or intermediate results. A stream s may be denoted by <e1, e2, . . . , en>, where ei is an extent. An example API call is ExtentCnt(s) to get the number of extents in the stream.

Fingerprints are provided for extents and streams. Fingerprints are desirably computed in such a way that they are essentially unique. That is, the probability of two different values having equal fingerprints is extremely small. The fingerprint of an extent e is denoted by FP(e) and the fingerprint of a stream s is denoted by FP(s). The fingerprint of the first n extents of a stream s is denoted by FP(s, n).

An example design of the data store comprises a cache, such as a centralized cache server. It desirably maintains a persistent, global data structure, which essentially is a set of pairs of <key, value>. Clients or job managers, for example, will desirably check with the cache server before performing an expensive computation.

Assume that all applications have a single input stream and a single output stream. For an application <F, C> with input stream “input_stream” and output stream “output_stream”, its cache entry comprises the following key and value pair:
key=<FP(F), FP(C)>
value=<<fp1, r1>, . . . , <fpn, rn>>

The key is the fingerprint of the “program” of an application. The value is a list of past computations of <F, C>. When a new computation of <F, C> of input s is completed with result r, <FP(s), r> is added into the list. The list may be ordered by the insertion times.

Consider an example scenario if there is such an entry for <F, C> in the cache, and if the same application <F, C> is run the next day. Essentially, it is determined whether any of the function has already been run and stored. If so, that stored data is used instead of computing that portion.

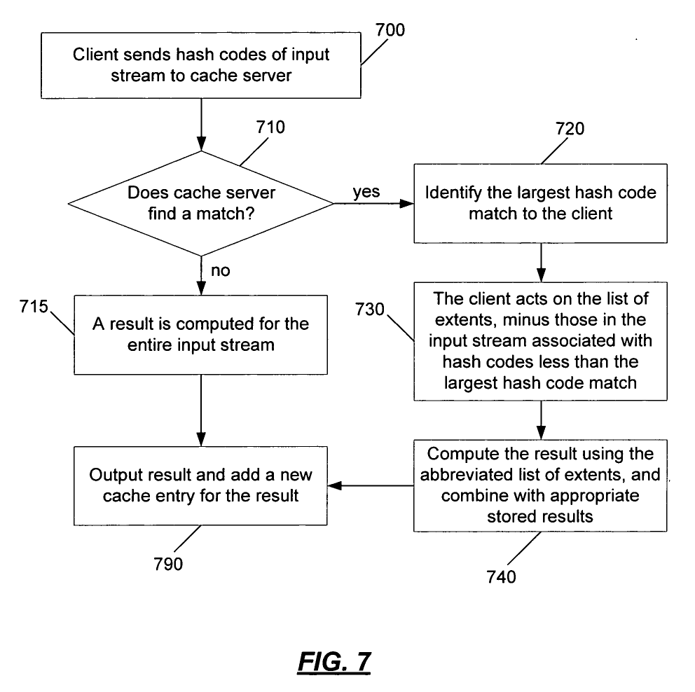

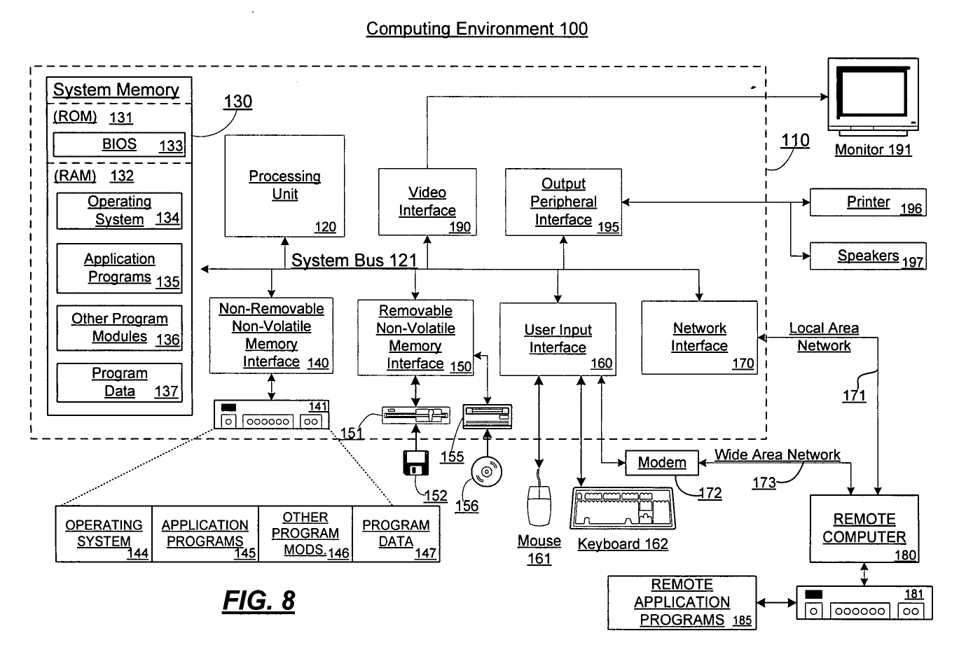

More particularly, consider the case in which the programs of F and C are not changed, with respect to FIG. 7. A client wants to compute F on an input stream that contains n extents. The client (e.g., job manager) sends <FP(is, 1), FP(is, 2), . . . , FP(is, n)> of the input stream to the cache server, at step 700. The cache server tries to find the largest i such that FP(is, i) is equal to some fpj in the value, at step 710. There are two cases:

(1) If the cache server finds an i and j such that FP(s,i)=fpj, at step 720. The cache server returns to the client the pair <i,rj>. Once the client receives this message, the following is performed, at step 730: C(rj, F(Truncate(input_stream, i))), where Truncate(s,i) returns the ordered list of extents in s without the first i extents. Upon completion, the result, at step 740, is exactly what is desired. The result is returned to the user, and a new cache entry is added for this result, at step 790, as described below, for example.

(2) If there is no such i, the cache server returns to the client the pair <-1, null>. Once the client receives this message, the computation of F is conducted from scratch, and a new cache entry is added upon completion, as described below with respect to steps 715 and 790.

If the programs of F and C are changed, output_stream =F(input_stream) is computed at step 715, and a new cache entry is added for this new computation, at step 790 as follows. For the cache server, add the following new cache entry:
key=<FP(F), FP(C)>
value=<<FP(input_stream), FP(output_stream>>

It may be desirable to impose a limit on the number of past results kept in the cache server for any particular <F, C>. This could be done by keeping only the results of the latest n computations of <F, C>, for example.

If a stream referenced by the cache server is deleted, the cache entry may be invalidated (e.g., either in the background, or the first time it is retrieved after the stream has been deleted). The cache server may optionally want to ensure that streams which it references are not deleted. This may be done by making a clone of the stream with a private name, for example, which will not be deleted by any other client.

Exemplary Computing Arrangement

FIG. 8 shows an exemplary computing environment in which example embodiments and aspects may be implemented. The computing system environment 100 is only one example of a suitable computing environment and is not intended to suggest any limitation as to the scope of use or functionality. Neither should the computing environment 100 be interpreted as having any dependency or requirement relating to any one or combination of components illustrated in the exemplary operating environment 100.

Numerous other general purpose or special purpose computing system environments or configurations may be used. Examples of well known computing systems, environments, and/or configurations that may be suitable for use include, but are not limited to, personal computers, server computers, hand-held or laptop devices, multiprocessor systems, microprocessor-based systems, set top boxes, programmable consumer electronics, network PCs, minicomputers, mainframe computers, embedded systems, distributed computing environments that include any of the above systems or devices, and the like.

Computer-executable instructions, such as program modules, being executed by a computer may be used. Generally, program modules include routines, programs, objects, components, data structures, etc. that perform particular tasks or implement particular abstract data types. Distributed computing environments may be used where tasks are performed by remote processing devices that are linked through a communications network or other data transmission medium. In a distributed computing environment, program modules and other data may be located in both local and remote computer storage media including memory storage devices.

With reference to FIG. 8, an exemplary system includes a general purpose computing device in the form of a computer 110. Components of computer 110 may include, but are not limited to, a processing unit 120, a system memory 130, and a system bus 121 that couples various system components including the system memory to the processing unit 120. The processing unit 120 may represent multiple logical processing units such as those supported on a multi-threaded processor. The system bus 121 may be any of several types of bus structures including a memory bus or memory controller, a peripheral bus, and a local bus using any of a variety of bus architectures. By way of example, and not limitation, such architectures include Industry Standard Architecture (ISA) bus, Micro Channel Architecture (MCA) bus, Enhanced ISA (EISA) bus, Video Electronics Standards Association (VESA) local bus, and Peripheral Component Interconnect (PCI) bus (also known as Mezzanine bus). The system bus 121 may also be implemented as a point-to-point connection, switching fabric, or the like, among the communicating devices.

Computer 110 typically includes a variety of computer readable media. Computer readable media can be any available media that can be accessed by computer 110 and includes both volatile and nonvolatile media, removable and non-removable media. By way of example, and not limitation, computer readable media may comprise computer storage media and communication media. Computer storage media includes both volatile and nonvolatile, removable and non-removable media implemented in any method or technology for storage of information such as computer readable instructions, data structures, program modules or other data. Computer storage media includes, but is not limited to, RAM, ROM, EEPROM, flash memory or other memory technology, CDROM, digital versatile disks (DVD) or other optical disk storage, magnetic cassettes, magnetic tape, magnetic disk storage or other magnetic storage devices, or any other medium which can be used to store the desired information and which can accessed by computer 110. Communication media typically embodies computer readable instructions, data structures, program modules or other data in a modulated data signal such as a carrier wave or other transport mechanism and includes any information delivery media. The term “modulated data signal” means a signal that has one or more of its characteristics set or changed in such a manner as to encode information in the signal. By way of example, and not limitation, communication media includes wired media such as a wired network or direct-wired connection, and wireless media such as acoustic, RF, infrared and other wireless media. Combinations of any of the above should also be included within the scope of computer readable media.

The system memory 130 includes computer storage media in the form of volatile and/or nonvolatile memory such as read only memory (ROM) 131 and random access memory (RAM) 132. A basic input/output system 133 (BIOS), containing the basic routines that help to transfer information between elements within computer 110, such as during start-up, is typically stored in ROM 131. RAM 132 typically contains data and/or program modules that are immediately accessible to and/or presently being operated on by processing unit 120. By way of example, and not limitation, FIG. 8 illustrates operating system 134, application programs 135, other program modules 136, and program data 137.

The computer 110 may also include other removable/non-removable, volatile/nonvolatile computer storage media. By way of example only, FIG. 8 illustrates a hard disk drive 140 that reads from or writes to non-removable, nonvolatile magnetic media, a magnetic disk drive 151 that reads from or writes to a removable, nonvolatile magnetic disk 152, and an optical disk drive 155 that reads from or writes to a removable, nonvolatile optical disk 156, such as a CD ROM or other optical media. Other removable/non-removable, volatile/nonvolatile computer storage media that can be used in the exemplary operating environment include, but are not limited to, magnetic tape cassettes, flash memory cards, digital versatile disks, digital video tape, solid state RAM, solid state ROM, and the like. The hard disk drive 141 is typically connected to the system bus 121 through a non-removable memory interface such as interface 140, and magnetic disk drive 151 and optical disk drive 155 are typically connected to the system bus 121 by a removable memory interface, such as interface 150.

The drives and their associated computer storage media discussed above and illustrated in FIG. 8, provide storage of computer readable instructions, data structures, program modules and other data for the computer 110. In FIG. 8, for example, hard disk drive 141 is illustrated as storing operating system 144, application programs 145, other program modules 146, and program data 147. Note that these components can either be the same as or different from operating system 134, application programs 135, other program modules 136, and program data 137. Operating system 144, application programs 145, other program modules 146, and program data 147 are given different numbers here to illustrate that, at a minimum, they are different copies. A user may enter commands and information into the computer 20 through input devices such as a keyboard 162 and pointing device 161, commonly referred to as a mouse, trackball or touch pad. Other input devices (not shown) may include a microphone, joystick, game pad, satellite dish, scanner, or the like. These and other input devices are often connected to the processing unit 120 through a user input interface 160 that is coupled to the system bus, but may be connected by other interface and bus structures, such as a parallel port, game port or a universal serial bus (USB). A monitor 191 or other type of display device is also connected to the system bus 121 via an interface, such as a video interface 190. In addition to the monitor, computers may also include other peripheral output devices such as speakers 197 and printer 196, which may be connected through an output peripheral interface 195.

The computer 110 may operate in a networked environment using logical connections to one or more remote computers, such as a remote computer 180. The remote computer 180 may be a personal computer, a server, a router, a network PC, a peer device or other common network node, and typically includes many or all of the elements described above relative to the computer 110, although only a memory storage device 181 has been illustrated in FIG. 8. The logical connections depicted in FIG. 8 include a local area network (LAN) 171 and a wide area network (WAN) 173, but may also include other networks. Such networking environments are commonplace in offices, enterprise-wide computer networks, intranets and the Internet.

When used in a LAN networking environment, the computer 110 is connected to the LAN 171 through a network interface or adapter 170. When used in a WAN networking environment, the computer 110 typically includes a modem 172 or other means for establishing communications over the WAN 173, such as the Internet. The modem 172, which may be internal or external, may be connected to the system bus 121 via the user input interface 160, or other appropriate mechanism. In a networked environment, program modules depicted relative to the computer 110, or portions thereof, may be stored in the remote memory storage device. By way of example, and not limitation, FIG. 8 illustrates remote application programs 185 as residing on memory device 181. It will be appreciated that the network connections shown are exemplary and other means of establishing a communications link between the computers may be used.

Although the subject matter has been described in language specific to structural features and/or methodological acts, it is to be understood that the subject matter defined in the appended claims is not necessarily limited to the specific features or acts described above. Rather, the specific features and acts described above are disclosed as example forms of implementing the claims.

What is claimed:

1. A computation method on a dataset, comprising:
performing a computation on a dataset to generate a first result;
receiving a change to a portion of the dataset;
performing the computation on the changed portion of the dataset to generate a second result; and
combining the second result and a portion of the first result corresponding to an unchanged portion of the dataset to generate a combined result.

2. The method of claim 1, further comprising:
storing the first result prior to receiving the change to the portion of the dataset; and
retrieving the portion of the first result corresponding to the unchanged portion of the dataset prior to combining.

3. The method of claim 1, wherein receiving the change to the portion of the dataset comprises appending new data to the dataset.

4. The method of claim 3, further comprising removing a second portion of the data from the dataset.

5. The method of claim 4, wherein the quantity of data in the second portion is based on the quantity of new data being appended to the dataset.

6. The method of claim 1, further comprising providing the combined result as a final computation result.

7. The method of claim 1, further comprising receiving a second change to a second portion of the dataset; performing the computation on the second changed portion of the dataset to generate a third result; and combining the third result and a portion of the second result corresponding to a recently unchanged portion of the dataset to generate another combined result.

8. A computation system for a dataset, comprising:
a computing device that performs a computation on a dataset to generate a first result, receives a change to a portion of the dataset, and performs the computation on the changed portion of the dataset to generate a second result;
a storage device that stores the first result; and
a combiner that combines the second result and a portion of the first result corresponding to an unchanged portion of the dataset to generate a combined result.

9. The system of claim 8, wherein the storage device is adapted to store the first result prior to the computing device receiving the change to the portion of the dataset, and the computing device is adapted to retrieve the portion of the first result corresponding to the unchanged portion of the dataset prior to providing the portion to the combiner.

10. The system of claim 8, wherein the change to the portion of the dataset comprises new data appended to the dataset.

11. The system of claim 10, wherein the computing device is adapted to remove a second portion of the data from the dataset.

12. The system of claim 11, wherein the quantity of data in the second portion is based on the quantity of new data appended to the dataset.

13. The system of claim 8, wherein the combiner is adapted to provide the combined result as a final computation result.

14. The system of claim 8, wherein the computing device is adapted to receive a second change to a second portion of the dataset, and perform the computation on the second changed portion of the dataset to generate a third result, and the combiner is adapted to combine the third result and a portion of the second result corresponding to a recently unchanged portion of the dataset to generate another combined result.

15. The system of claim 8, wherein the storage device comprises a cache server

16. A computation method on a dataset, comprising:
determining whether a fingerprint of data in an input stream matches a fingerprint of data stored in a storage device;
if so, then identifying the largest fingerprint match, and performing a computation on a portion of the data in the input stream to generate a first result, the portion based on the largest fingerprint match; and
if not, then performing the computation on the data in the input stream to generate a second result.

17. The method of claim 16, wherein if there is a match, then further comprising combining the first result with a stored result corresponding to a portion of the data in the input stream that had already been computed, to generate a third result.

18. The method of claim 17, further comprising storing the second result or the third result in the storage device.

19. The method of claim 16, wherein the portion corresponds to the data in the input stream that has not been previously subjected to the computation.

20. The method of claim 16, wherein the fingerprint comprises a hash code.
